(19) United States
(12) Patent Application Publication
(10) Pub. No.: US 2016/0092532 A1
(43) Pub. Date: Mar. 31, 2016

(54) LOAD-BALANCING INBOUND REAL-TIME DATA UPDATES FOR A SOCIAL NETWORKING SYSTEM

(71) Applicant: Facebook, Inc., Menlo Park, CA (US)

(72) Inventors: Yuntao Jia, Foster City, CA (US); Jun Ge, Palo Alto, CA (US); Eric Seth Pelz, Los Angeles, CA (US)

(21) Appl. No.: 14/500,522

(22) Filed: Sep. 29, 2014

(51) Int. Cl. G06F 17/30; H04L 29/08; H04L 12/911

(52) U.S. Cl. CPC G06F 17/30575; H04L 47/726; H04L 67/306; G06F 17/30345

(57) ABSTRACT

Some embodiments include a method of operating a load-balancing engine for a social networking system receiving real-time updates from mobile devices. The method can include receiving a location-based record update associated with a user account; writing the location-based record update separately to at least two different databases; forwarding the location-based record update to an analytic engine of a web service computer system; receiving a first derivative dataset computed based on the location-based record from the analytic engine; and writing the first derivative dataset separately to the at least two different databases.

### RELATED FIELD

At least one embodiment of this disclosure relates generally to load-balancing computer servers, and in particular to load-balancing of computer servers to process and store real-time updates from mobile devices.

### BACKGROUND

A social networking system can connect users to one another. For example, a social networking system can provide near instantaneous communication between users. Real-time updates from the users (e.g., through their mobile devices) can facilitate interactions between such users and social objects (e.g., other users or entities represented in the social networking system). For example, real-time updates can include location-based updates (e.g., exact location, relative location, or velocity) from user devices to the social networking system. Based on the location-based updates of one user, the social networking system can provide social networking services to the user and other users (e.g., based on the movements of that one user). For example, the social networking system can present advertisement, friend recommendation, travel-related updates, and other location-based context tagging social interactions based on the location-based updates and location-based context derived from the location-based updates.

To protect such data (e.g., the communication messages and/or the real-time updates), the social networking systems typically require sophisticated backend servers to store and process the data. However, because of the frequency of the communication messages and/or the data updates and the scalability of most social networking systems, the back-end servers may be overwhelmed by massive amount of data flow that needs to be stored and processed.

### BRIEF DESCRIPTION OF THE DRAWINGS

FIG. 1 is a block diagram illustrating a system environment for a social networking system that receives real-time updates from client devices, in accordance with various embodiments.

FIG. 2 is a data flow diagram illustrating a social networking system load-balancing real-time updates from client devices, in accordance with various embodiments.

FIG. 3A is a block diagram illustrating a data structure of a record database, in accordance with various embodiments.

FIG. 3B is a block diagram illustrating a data structure of a user profile persistent storage, in accordance with various embodiments.

FIG. 3C is a block diagram illustrating a data structure of a user profile data cache, in accordance with various embodiments.

FIG. 4 is a flow chart of a method of operating a load-balancing computer system as a proxy to access distributed databases storing real-time update records, in accordance with various embodiments.

FIG. 5 is a flow chart of a method of operating a load-balancing computer system to implement failsafe scenarios, in accordance with various embodiments.

FIG. 6 is a high-level block diagram of a system environment suitable for a social networking system, in accordance with various embodiments.

FIG. 7 is a block diagram of an example of a computing device, which may represent one or more computing device or server described herein, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of the invention described herein.

### DETAILED DESCRIPTION

Embodiments include a system architecture of computer servers to load-balance real-time update data (e.g., location-based updates) from mobile devices. Some embodiments include real-time gateways that receive raw update data from the mobile devices and route such data to a load-balancing computer system. The load-balancing computer system “double writes” (e.g., duplicates) the raw update data to both a production cell database 108A and a backup cell database 108B. The databases can be distributed and can be non-relational databases (e.g., HBase). In parallel to the double write, the load-balancing computer system sends the raw update data to a computation server system to compute analytics (e.g., location-based context data) derived from the raw update data. For example, the analytics can be location-based context associated with a user account, including current city, last known location, “hot spots” (i.e., frequently-visited locations), “significant moves” (i.e., movements of the user considered “significant” in space and/or time by the computation server system), speeds of movement, traveling companions, or any combination thereof.

A computation server system can store at least a portion of the analytics (e.g., the current city and the frequently visited locations) into persistent storage and at least a portion to a cache memory system (e.g., significant moves and last known location). The portion stored in the cache memory system can be a subset of the portion stored in the persistent storage. The computation server system can request a double write of at least another portion of the analytics to the production cell and the backup cell by using the load-balancing computer system as a proxy.

The disclosed system architecture provides load-balancing to handle high volumes of data updates such that instantaneous access to the updates are available in substantially real-time and the computation server system can start data analytics in substantially real-time. The disclosed system architecture is further advantageous by providing a method of providing redundant data storage through double writing into a production cell database 108A and a backup cell database 108B.

Various embodiments of the disclosed system architecture can be implemented in a social networking system. Social networking systems commonly provide mechanisms enabling users to interact with objects and other users both within and external to the context of the social networking system. To facilitate such interactions, the social networking system can receive frequent location-based updates from mobile devices associated with user accounts of the social networking system. The social networking system can then calculate location-based context information from the location-based updates. The social networking system can have as many as hundreds of millions to over a billion user accounts. At least some of the user accounts may have mobile devices updating nearly every 15 minutes. Accordingly, the social networking system can greatly benefit from a scalable and load-balanced system architecture to manage the large quantity of location-based data.

### Social Networking System Overview

A social networking system user may be an individual or any other entity, e.g., a business or other non-person entity. The social networking system may utilize a web-based interface or a mobile interface comprising a series of inter-connected pages displaying and enabling users to interact with social networking system objects and information. For example, a social networking system may display a page for each social networking system user comprising objects and information entered by or related to the social networking system user (e.g., the user's “profile”). Social networking systems may also have pages containing pictures or videos, dedicated to concepts, dedicated to users with similar interests (“groups”), or containing communications or social networking system activity to, from or by other users. Social networking system pages may contain links to other social networking system pages, and may include additional capabilities, e.g., search, real-time communication, content-item uploading, purchasing, advertising, and any other web-based inference engine or ability. It should be noted that a social networking system interface may be accessible from a web browser or a non-web browser application, e.g., a dedicated social networking system application executing on a mobile computing device or other computing device. Accordingly, “page” as used herein may be a web page, an application interface or display, a widget displayed over a web page or application, a box or other graphical interface, an overlay window on another page (whether within or outside the context of a social networking system), or a web page external to the social networking system with a social networking system plug in or integration capabilities.

As discussed above, a social graph can include a set of nodes (representing social networking system objects, also known as social objects) interconnected by edges (representing interactions, activity, or relatedness). A social networking system object may be a social networking system user, nonperson entity, content item, group, social networking system page, location, application, subject, concept, or other social networking system object, e.g., a movie, a band, or a book. Content items can include anything that a social networking system user or other object may create, upload, edit, or interact with, e.g., messages, queued messages (e.g., email), text and SMS (short message service) messages, comment messages, messages sent using any other suitable messaging technique, an HTTP link, HTML files, images, videos, audio clips, documents, document edits, calendar entries or events, and other computer-related files. Subjects and concepts, in the context of a social graph, comprise nodes that represent any person, place, thing, or idea.

A social networking system may enable a user to enter and display information related to the user's interests, education and work experience, contact information, demographic information, and other biographical information in the user's profile page. Each school, employer, interest (for example, music, books, movies, television shows, games, political views, philosophy, religion, groups, or fan pages), geographical location, network, or any other information contained in a profile page may be represented by a node in the social graph. A social networking system may enable a user to upload or create pictures, videos, documents, songs, or other content items, and may enable a user to create and schedule events. Nodes in the social graph may represent content items and events.

A social networking system may provide various means to interact with nonperson objects within the social networking system. For example, a user may form or join groups, or become a fan of a fan page within the social networking system. In addition, a user may create, download, view, upload, link to, tag, edit, or play a social networking system object. A user may interact with social networking system objects outside of the context of the social networking system. For example, an article on a news web site might have a “like” button that users can click. In each of these instances, the interaction between the user and the object may be represented by an edge in the social graph connecting the node of the user to the node of the object. A user may use location detection functionality (such as a GPS receiver on a mobile device) to “check in” to a particular location, and an edge may connect the user's node with the location's node in the social graph.

A social networking system may provide a variety of communication channels to users. For example, a social networking system may enable a user to email, instant message, or text/SMS message, one or more other users; may enable a user to post a message to the user's wall or profile or another user's wall or profile; may enable a user to post a message to a group or a fan page; or may enable a user to comment on an image, wall post or other content item created or uploaded by the user or another user. In least one embodiment, a user posts a status message to the user's profile indicating a current event, state of mind, thought, feeling, activity, or any other present-time relevant communication. A social networking system may enable users to communicate both within and external to the social networking system. For example, a first user may send a second user a message within the social networking system, an email through the social networking system, an email external to but originating from the social networking system, an instant message within the social networking system, and an instant message external to but originating from the social networking system. Further, a first user may comment on the profile page of a second user, or may comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection is a social network edge. Being friends in a social networking system may allow users access to more information about each other than would otherwise be available to unconnected users. For example, being friends may allow a user to view another user's profile, to see another user's friends, or to view pictures of another user. Likewise, becoming friends within a social networking system may allow a user greater access to communicate with another user, e.g., by email (internal and external to the social networking system), instant message, text message, phone, or any other communicative interface. Being friends may allow a user access to view, comment on, download, endorse, or otherwise interact with another user's uploaded content items. Establishing connections, accessing user information, communicating, and interacting within the context of the social networking system may be represented by an edge between the nodes representing two social networking system users.

In addition to explicitly establishing a connection in the social networking system, users with common characteristics may be considered connected (such as a soft or implicit connection) for the purposes of determining social context for use in determining the topic of communications. In at least one embodiment, users who belong to a common network are considered connected. For example, users who attend a common school, work for a common company, or belong to a common social networking system group may be considered connected. In at least one embodiment, users with common biographical characteristics are considered connected. For example, the geographic region users were born in or live in, the age of users, the gender of users and the relationship status of users may be used to determine whether users are connected. In at least one embodiment, users with common interests are considered connected. For example, users' movie preferences, music preferences, political views, religious views, or any other interest may be used to determine whether users are connected. In at least one embodiment, users who have taken a common action within the social networking system are considered connected. For example, users who endorse or recommend a common object, who comment on a common content item, or who RSVP to a common event may be considered connected. A social networking system may utilize a social graph to determine users who are connected with or are similar to a particular user in order to determine or evaluate the social context between the users.

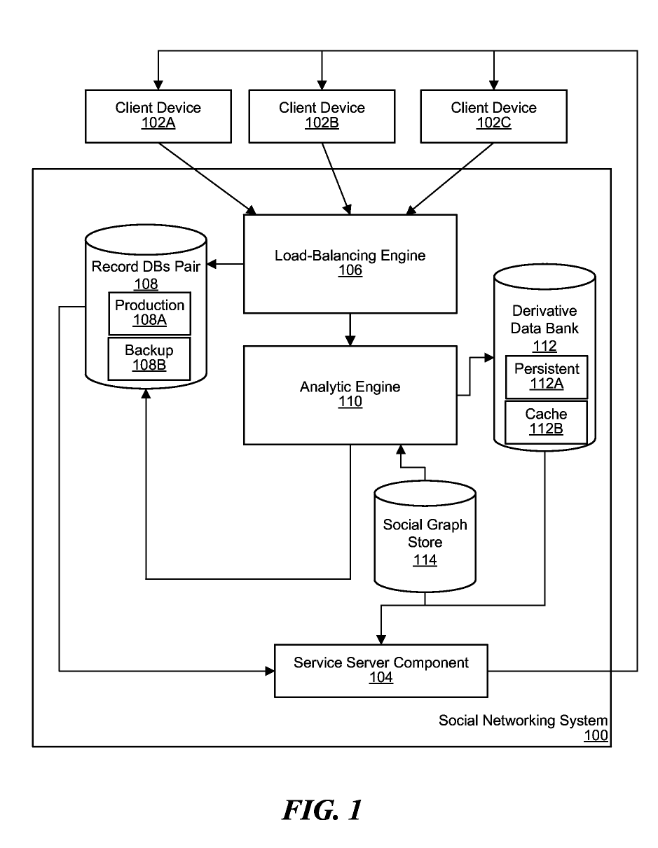

FIG. 1 is a block diagram illustrating a system environment for a social networking system 100 that receives real-time updates from client devices, in accordance with various embodiments. The social networking system 100 can communicate with one or more client devices (e.g., a client device 102A, a client device 102B, and a client device 102C, collectively as the “client devices 102”). For example, the client devices 102 can be mobile computing devices running a social networking application or stationary computing devices accessing the social networking system 100 via a web browser.

The social networking system 100 provides a social networking service through a service server component 104. For example, the service server component 104 can be a Web server that communicates with web browsers at least some of the client devices 102. The service server component 104 can be an application programming interface (API) interfacing with mobile applications on at least some of the client devices 102. In various embodiments, the social networking system 100 requests location information of users (e.g., associated with social networking accounts) via the client devices 102. The social networking system 100 can use the location information to tailor social networking services to one or more users (e.g., to select specific content for the users, to make decisions regarding the social network services, or to facilitate other services provided through the social networking system 100).

In various embodiments, the social networking system 100 can receive real-time updates from the client devices 102. For example, the real-time updates can be real-time location information from the client devices 102. Such location information can be triggered by an application running on a client device. For example, the application can determine when to update the social networking system 100. For another example, the social networking system 100 can request the real-time updates from the client devices 102. The determination of whether to update may be based on a schedule (e.g., a periodic schedule), one or more user related or user device related conditions, state of the social networking system 100, requests from one or more social networking accounts, or any combination thereof.

When the client devices 102 send the real-time updates (e.g., location information) to the social networking system 100, a load-balancing engine 106 processes the real-time updates. The load-balancing engine 106 can store the real-time updates into a record databases pair 108. The record databases pair 108 includes a production cell database 108A and a backup cell database 108B. In some embodiments, the production cell database 108A is used to serve data requests and the backup cell database 108B is used only to provide backup data in case of failure of the production cell database 108A. The “production cell” and the “backup cell” labels are designated by the load-balancing engine 106 and can be switched dynamically when the load-balancing engine 106 determines that the current production cell database 108A is failing.

The record databases pair 108, for example, can be both implemented as HBase databases or other distributed and scalable databases. In some embodiments, the load-balancing engine 106 can also pipe the real-time updates to an analytic engine 110. In some embodiments, the load-balancing engine 106 can send the real-time updates in parallel to both the record databases pair 108 and the analytic engine 110 substantially simultaneously.

The analytic engine 110 can compute derivative updates associated with social networking accounts based on the real-time updates. The derivative updates can be stored in a derivative databank 112. In some embodiments, the derivative databank 112 is implemented with a persistent storage subsystem 112A and a cache memory subsystem 112B, where the cache memory subsystem 112B stores a subset of data, from the persistent storage subsystem 112A, that is frequently accessed. The derivative updates can be solely based on the real-time updates. For example, where the real-time updates are time-stamped raw location data associated with a user, the analytic engine 110 can estimate a speed of travel for the user based on multiple time-stamped raw location data. The derivative updates can also be determined based on the real-time updates and other information available in the social networking system 100. For example, the analytic engine 110 can access a social graph store 114 of the social networking system 100. For example, where the real-time updates are time-stamped raw location data associated with a user, the analytic engine 110 can determine a group of friends traveling together or determine nearby friends for the user based on the time-stamped raw location data of a user account and a social graph associated with the user account.

In some embodiments, the analytic engine 110 can categorize different types of derivative data. For example, the analytic engine 110 can log one or more types of derivative data into the record databases pair 108 to keep a historical record of the derivative data associated with a user account. The persistent storage subsystem 112A can have a slower access speed and higher storage capacity than the cache memory subsystem 112B. For example, the analytic engine 110 can store one or more types of derivative data into the persistent storage subsystem 112A and store a subset of those derivative data into the cache memory subsystem 112B. In other embodiments, the analytic engine 110 can store different types of derivative data into the persistent storage subsystem 112A and the cache memory subsystem 112B.

As the derivative data becomes available in the derivative databank 112, the service server component 104 can adjust and/or provision its services to the client devices 102 accordingly. For example, based on the computed list of nearby friends, the service server component 104 can notify a client device of the presence of other users. For another example, based on the computed list of traveling companions, the service server component 104 can determine that a group of users are traveling, and would delay push messages to those users' devices until those users stop traveling. Other types of provisioning and adjustment can be executed in response to updating of the derivative data and/or raw updates. In some embodiments, the service server component 104 can also provide personal historical records (e.g., historical location-based records) associated with a user account to a client device that authenticates as the user account.

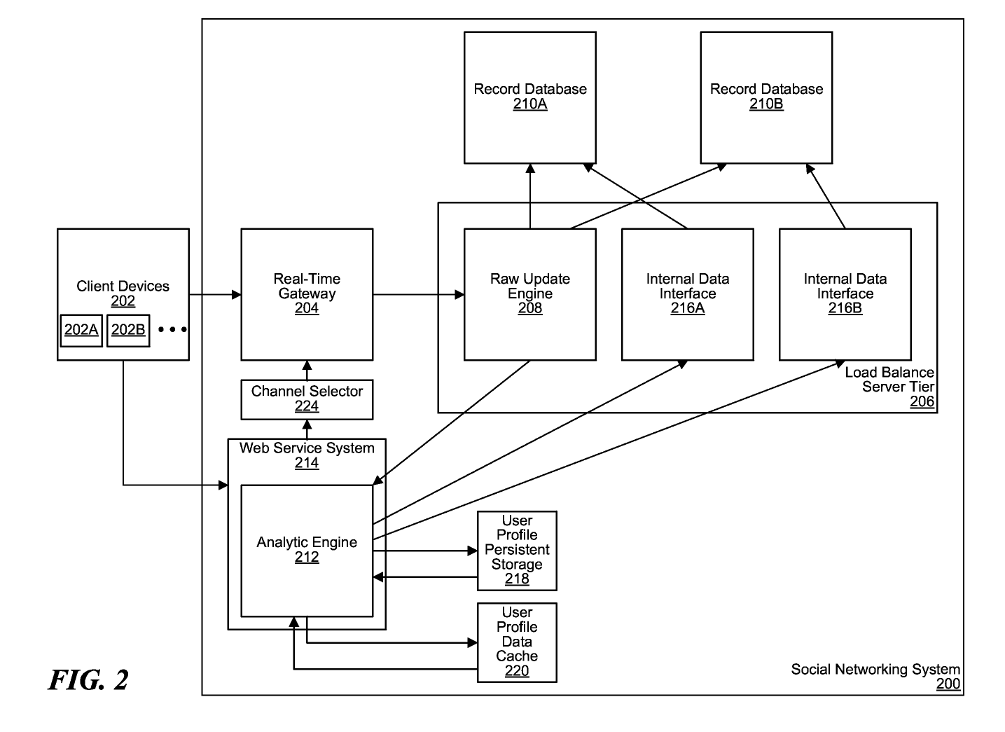

FIG. 2 is a data flow diagram illustrating a social networking system 200 load-balancing real-time updates from client devices, in accordance with various embodiments. The social networking system 200 can be the social networking system 100 of FIG. 1. The social networking system 200 can receive real-time updates from client devices 202 (e.g., a client device 202A, a client device 202B, etc.) at a real-time gateway 204. The client devices 202 can be the client devices 102 of FIG. 1. In some embodiments, the social networking system 200 can include multiple real-time gateways, each serving a region of client devices. In some embodiments, social networking applications running on the client devices 202 can determine which of the real-time gateways to communicate with. Likewise, in some embodiments, the social networking system 200 can also determine which real-time gateway can facilitate communication with the client devices 202.

A social networking application running on one of the client devices 202 can send an update message (e.g., location data) to the real-time gateway 204. Then, the real-time gateway 204 can forward the update message to a load-balancing server tier 206 (e.g., the load-balancing engine 106 of FIG. 1). The load-balancing server tier 206 can be implemented with one or more computer server. For example, each of the computer server can implement a Java package containing executable instructions to implement one or more methods of load-balancing consistent with various embodiments. In some embodiments, the load-balancing server tier 206 is configured to provide location-based services. In these embodiments, the load-balancing server tier 206 serves to facilitate storage of location updates and to provide location data to other applications running in the social networking system 200.

The load-balancing server tier 206 includes a raw update engine 208 (e.g., part of the Java package). The raw update engine 208 processes the update message from the client devices 202 “as is,” for storage into record databases (e.g., a record database 210A and a record database 210B, collectively as “record databases 210”). For example, the record databases 210 can be the record databases pair 108 of FIG. 1. For example, the record database 210A can serve as a production cell to store and serve historical update records from, for example, the client device 202A or client devices associated with a user account of the social networking system 200. The raw update engine 208 can perform a “double write” of the update message into the record databases 210. The double write operation involves writing the same dataset (e.g., the update message) separately to at least both the record database 210A and the record database 210B.

The double write operation advantageously creates an instantaneous or substantially instantaneous backup copy in parallel without requiring specific interaction between the record databases 210 themselves to establish the backup. The double write operation can occur in parallel or sequentially. The two write operations of the “double write” can occur substantially simultaneous to each other. In some embodiments, instead of executing a double write operation, the raw update engine 208 can execute a “multi-write” operation that involves more than two write operations. Because the double writes occur substantially simultaneously, there is almost no time when there is no redundancy for the update message. This enables the load-balancing server tier 206 to switch between the production cell and the backup cell at any given time when the current production cell appears to be failing.

The raw update engine 208 also forwards update messages received from the real-time gateway 204 to an analytic engine 212 (e.g., the analytic engine 110 of FIG. 1) in a web service system 214 (e.g., the service server component 104 of FIG. 1). The web service system 214 includes one or more computer servers that generate a user interface to provide to the client devices 202. The user interface can be presented through a web browser in a client device or a mobile application in a client device.

The analytic engine 212 is a component (e.g., a hardware chip, a software program, or a combination thereof) that computes derivative data based on content of an update message and/or metadata associated with the update message. Update messages can contain raw data (e.g., raw location coordinates) provided from the client devices 202. For example, the metadata of an update message can include a timestamp, a device ID (i.e., from where the update message is sent), a user account ID associated with the update message, any other information relating to the generation and/or delivery of the update message, or any combination thereof.

In the example of location-based information, the analytic engine 212 can compute location-based derivative data (e.g., location-based context data) based on raw location information and speed/velocity information embedded in the update messages. For example, derivative data can include “hotspots,” which are frequently visited location by a user account. Derivative data can also include “significant moves,” which are locations determined by the analytic engine 212 to have been visited by the user account and considered “significant” based on lapse in distance or time from a previous significant move. For example, the significant moves can be computed based on significant changes (e.g., where “significance” is measured by a threshold in distance and/or time). The derivative data can pertain to a specific user account, a specific client device, a specific update message, a specific context (e.g., as determined by the analytic engine 212), or any combination thereof.

The analytic engine 212 can compute derivative data based solely on the raw content of the update message(s) and/or the metadata associated with the update message(s). The analytic engine 212 can also compute derivative data based on the raw content and/or the metadata and other data available to the analytic engine 212. For example, user profile information can be stored in a user profile persistent storage 218 (e.g., the derivative databank 112A of FIG. 1) and/or a user profile data cache 220 (e.g., the derivative databank 112B of FIG. 1). The user profile persistent storage 218 provides persistent storage of user related information (e.g., user profiles and a social graph in the social networking system 200 that connects the user profiles). The user profile data cache 220 similarly caches user related information for the web service system 214.

The user profile persistent storage 218 is implemented with one or more persistent data storage devices. The user profile data cache 220 is implemented with one or more data cache memory devices that provide high-speed memory storing at least a subset of the user related information in the user profile persistent storage 218. The high-speed memory can be implemented by volatile memory, flash memory, or other memory devices with a faster access speed (e.g., on average) than the persistent data storage devices of the user profile persistent storage 218. In some embodiments, the user profile data cache 220 can store information that is to be written into the user profile persistent storage 218.

The analytic engine 212 can access either or both the user profile persistent storage 218 and the user profile data cache 220 for the user-related information to compute the derivative data. The analytic engine 212 can be configured to determine required data to compute different types of derivative data. In some embodiments, the analytic engine 212 can first determine whether the required data is available in the user profile data cache 220 before determining whether the required data is available in the user profile persistent storage 218. The sequence enables the analytic engine 212 to utilize the high-speed characteristic of the user profile data cache 220. In some embodiments, the content of the user profile data cache 220 is dynamic chosen, depending on the access frequency of the data or data type. For example, the user profile data cache 220 can serve to cache any recently accessed data from the user profile persistent storage 218 and regularly delete cached data to free up memory space (e.g., by deleting data that has not being accessed for the longest periods of time). In other embodiments, the content of the user profile data cache 220 is chosen based on the data type (e.g., socially connections of user accounts, location-related privacy settings of the user accounts, etc.).

In some embodiments, the analytic engine 212 is also configured to store at least a portion of the computed derivative data in the user profile persistent storage 218 and at least a portion of the computed derivative data in the user profile data cache 220. In some embodiments, the portion stored in the user profile persistent storage 218 can overlap with the portion stored in the user profile data cache 220. In some embodiments, the portions do not overlap. In some embodiments, the portion stored in the user profile data cache 220 is a subset of the portion stored in the user profile persistent storage 218. For example, the current city and hotspot(s) of a user account in the social networking system 200 can be stored in the user profile persistent storage 218; and the significant moves and/or last known location can be stored in the user profile data cache 220.

For record keeping, the analytic engine 212 can be configured to pipe at least a portion of the computed derivative data back to the record databases 210, e.g., via the load-balancing server tier 206. In the example of location-based updates, the analytic engine 212 can send the computed significant moves to the load-balancing server tier 206 for storage into the record databases 210. For example, the analytic engine 212 can forward the computed derivative data to an internal data interface 216A and an internal data interface 216B (e.g., both parts of the Java package). The internal data interfaces 216A and 216B can be applications that serve as proxies for the web service system 214 to write data to the record databases 210. In some embodiments, at least one of the internal data interfaces 216A and 216B also serves as a proxy for the web service system 214 to read data from one of the record databases 210 serving as the production cell. The forwarding of the computed derivative data can occur in parallel or in sequence.

The analytic engine 212 can send the computed derivative data in parallel or in sequence to the record databases 210. The analytic engine 212 can send the at least two copies of the computed derivative data substantially simultaneously to the internal data interfaces 216A and 216B. The internal data interface 216A can write the derivative data that it receives to the record database 210A and the internal data interface 216B can write the derivative data that it receives to the record database 210B.

The derivative data and/or the recorded raw data associated with a user account may be accessible by the user account. For example, a user account logged in through the client device 202A can request data access directly to the web service system 214. The web service system 214 can determine where the requested data is stored (e.g., in the user profile persistent storage 218, the user profile data cache 220, one of the record databases 210, or a combination thereof). The web service system 214 can then retrieve the requested data from the fastest available storage (e.g., preferring the user profile data cache 220 over the user profile persistent storage 218 and preferring the user profile persistent storage 218 over the production cell of the record databases 210.

If the requested data is in the record databases 210, then the web service system 214 can access the production cell of the record databases 210 via one of the internal data interfaces 216. That is, the web service system 214 can access one of the internal data interfaces 216 corresponding to the production cell. For example, the internal data interface 216A can correspond to the record database 210A, which is configured as the production cell. In that case, any data request from the web service system 214 is piped through the internal data interface 216A.

In response to a request for location-based data from the client device 202A, the web service system 214 can retrieve the requested data through one of the internal data interfaces 216A and 216B, the user profile persistent storage 218, the user profile data cache 220, or a combination thereof. In some embodiments, the web service system 214 directly responds with the requested data back to the client device 202A. In some embodiments, the web service system 214 can determine a real-time gateway (e.g., the real-time gateway 204) corresponding to the client device 202A and forward the requested data to the real-time gateway. In turn, the real-time gateway can forward the requested data back to the requesting client device.

The architecture described above enables data redundancy by having the load-balancing server tier 206 double writing to the record databases 210. The record database that serves as the production cell can be used as the sole source to respond to data requests. Because of the double writes, at any given time when error counts of the production cell exceeds a threshold level, the record database serving as the backup cell can be instantaneous assigned the role as the production cell while switching the record database. In some embodiments, in response to each access to the record databases 210, the load-balancing server tier 206 can update a first error count associated with the record database 210A and a second error count associated with the record database 210B. The load-balancing server tier 206 can maintain more than one error count for each of the record databases 210, for example, one for write operation errors and one for read operation errors. The error counts can also be reset periodically (e.g., every 10 days).

Other than error count, the load-balancing server tier 206 can perform consistency check between the record databases 210. For example, the load-balancing server tier 206 can schedule consistency checks based on a schedule (e.g., using a CRON job). Alternatively or in addition, the load-balancing server tier 206 can monitor for certain conditions that can trigger a consistency check. The consistency check can be an asynchronous process. For example, for every preset number (e.g., 10,000) of data requests (e.g., any data requests, data write requests, or data read requests), the load-balancing server tier 206 can trigger a consistency check. The consistency check can be for all data in the record databases 210 or a subset of the data in the record databases 210. For example, the consistency check can be limited to records related to a user account associated with the most recent data request that triggered the consistency check.

When a consistency check fails (e.g., there are more than a threshold number of inconsistencies), all of the data in the production cell is copied to the backup cell. While the records are being copy over, the production cell and/or the backup cell can continue to process incoming data. For example, incoming data can be first saved to staging areas of the record databases 210 before being saved to persistent storages of the record databases 210. This enables the record databases 210 to accumulate incoming data while the backup cell is replacing its existing database with the database of the production cell (e.g., replacement can occur in the persistent storage space instead of the staging area). In some cases, the time to replace the data in the backup cell can take up to several hours.

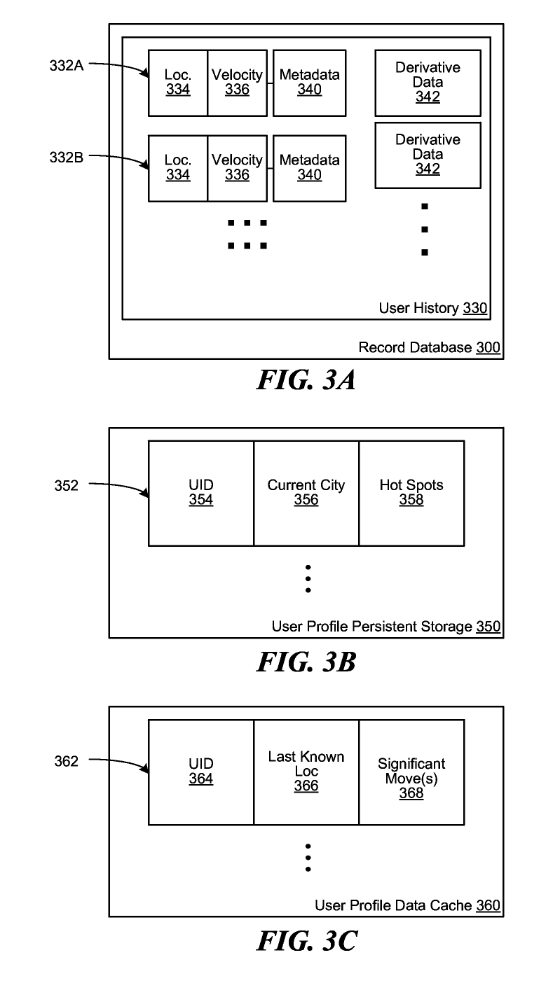

FIG. 3A is a block diagram illustrating a data structure of a record database 300 (e.g., one of the record databases 210 of FIG. 2), in accordance with various embodiments. The record database 300 can include one or more user histories (e.g., a user history 330). The user history 330 can store all historical records in the lifetime of a user account or a subset of the historical records in the lifetime. For example, the record database 300 can maintain a rolling window of most up-to-date location-based records. The rolling window can be maintained by having a threshold number of records in the user history 330, a threshold storage space for the user history 330, or a threshold time difference based on the timestamps of the records in the user history 330.

The user history 330 can include raw records (e.g., a raw record 332A, a raw record 332B, etc., collectively as the “raw records 332”). The raw records 332 can include a location entry 334 that includes a coordinate from a computing device associated with the user account. The coordinate can be a global positioning system (GPS) coordinate. The coordinate can be two-dimensional or three-dimensional. Each of the raw records 332 can include a velocity entry 336. The velocity entry 336 can include the speed (i.e., the magnitude of the velocity) of the computing device associated with the user account.

The user history 330 can also include metadata records (e.g., a metadata record 340) corresponding to the raw records 332. For example, the metadata record 340 can include a timestamp, a device ID, a user ID, or any combination thereof. The user history 330 can further include the derivative data records (e.g., a derivative data record 342) associated with the same user account as the raw records 332.

FIG. 3B is a block diagram illustrating a data structure of a user profile persistent storage 350 (e.g., the user profile persistent storage 218 of FIG. 2), in accordance with various embodiments. The user profile persistent storage 350 can include user profile records (e.g., a user profile record 352). The user profile record 352 can include numerous user account related information. Amongst those user account related information, the user profile record 352 can include location-based context information for the user account. For example, the user profile record 352 can include a user ID 354 of the user account, a current city 356 of the user account, hotspots 358 of the user account, or any combination thereof.

FIG. 3C is a block diagram illustrating a data structure of a user profile data cache 360 (e.g., the user profile data cache 220 of FIG. 2), in accordance with various embodiments. The user profile data cache 360 can include user profile records (e.g., a user profile record 362), similar to the user profile persistent storage 350. Each of the user profile records in the user profile data cache 360 can correspond to a user profile record in the user profile persistent storage 350. In some embodiments, contents of the user profile records in the user profile data cache 360 are subsets of contents of the corresponding user profile records in the user profile persistent storage 350.

The user profile record 362 can include location-based context information for a user account. For example, the user profile record 362 can include a user ID 364 of the user account, last known location 366 of the user account, and one or more recent significant moves 368 of the user account.

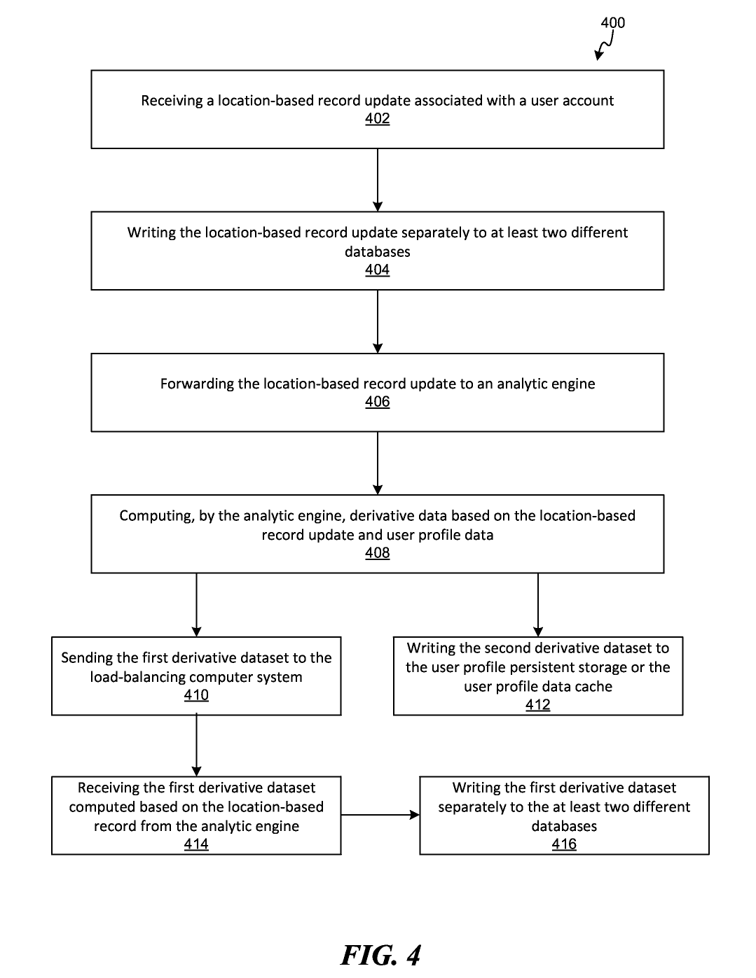

FIG. 4 is a flow chart of a method 400 of operating a load-balancing computer system (e.g., the load-balancing engine 106 of FIG. 1 or the load-balancing server tier 206 of FIG. 2) as a proxy to access distributed databases storing real-time update records, in accordance with various embodiments. In block 402, the load-balancing computer system receives a location-based record update associated with a user account. For example, the load-balancing computer system can receive the location-based record update from a real-time gateway (e.g., the real-time gateway 204 of FIG. 2) that services multiple mobile devices. At least one of the mobile devices can be associated with the user account. The location-based record update can include a raw location record associated with the user account and metadata associated with the raw location record.

In block 404, the load-balancing computer system writes the location-based record update separately to at least two different databases (e.g., the record databases pair 108 of FIG. 1 or the record databases 210 of FIG. 2). The databases are distributed and scalable databases. The databases can be non-relational databases, e.g., HBase databases. Block 404 can include two substantially simultaneous write operations to record databases (e.g., the record databases pair 108 of FIG. 1 or the record databases 210 of FIG. 2).

In block 406, the load-balancing computer system forwards the location-based record update to an analytic engine (e.g., the analytics engine 110 of FIG. 1 or the analytics engine 212 of FIG. 2) of a web service computer system (e.g., the service server component 104 of FIG. 1 or the web service system 214 of FIG. 2).

In response in block 408, the analytic engine computes derivative data based on the location-based record update and user profile data. The user profile data can be accessible from a user profile persistent storage (e.g., the persistent storage subsystem 112A of FIG. 1 or the user profile persistent storage 218 of FIG. 2) or a user profile data cache (e.g., the data cache subsystem 112B of FIG. 1 or the user profile data cache 220 of FIG. 2) coupled to the web service computer system. The derivative data including a first derivative dataset to be stored into the databases and a second derivative dataset to be stored in the user profile persistent storage and/or the user profile data cache. The first derivative dataset can include a significant movement of the user account.

In block 410, the analytic engine sends the first derivative dataset to the load-balancing computer system. In parallel to block 410, or before or after block 410, the analytic engine can write, in block 412, the second derivative dataset to the user profile persistent storage or the user profile data cache without sending the second derivative dataset to the load-balancing computer system.

In block 414, the load-balancing computer system receives the first derivative dataset computed based on the location-based record from the analytic engine. Receiving the first derivative dataset can include receiving at least two separate copies of the first derivative dataset at two data interface program instances executing in the load-balancing computer system. In block 416, the load-balancing computer system writes the first derivative dataset separately to the at least two different databases. For example, a data interface program instance can route a data request from the web service computer system to at least one of the databases serving as a production cell.

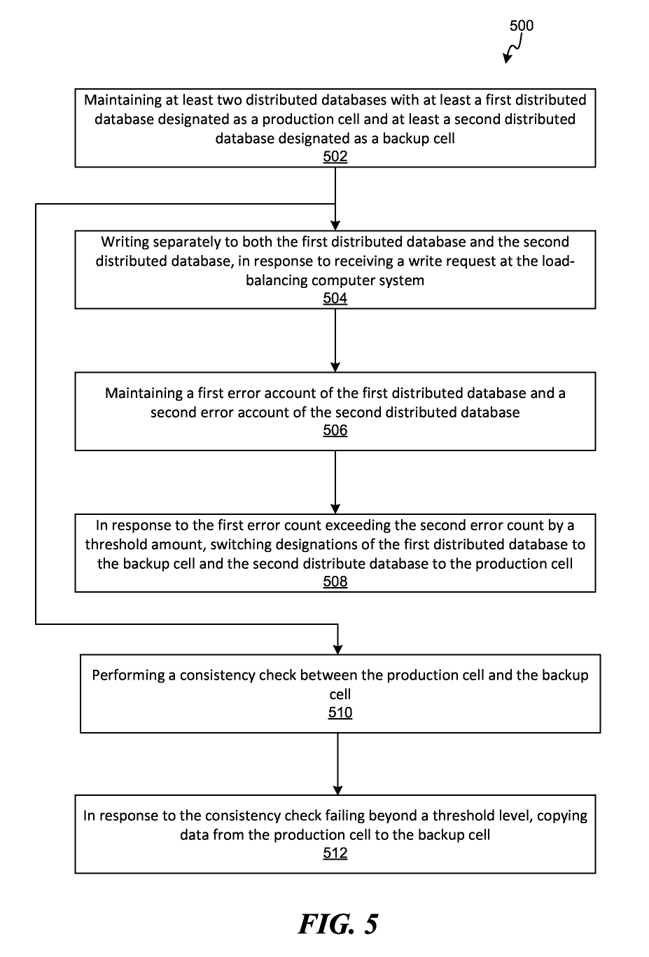

FIG. 5 is a flow chart of a method 500 of operating a load-balancing computer system (e.g., the load-balancing engine 106 of FIG. 1 or the load-balancing server tier 206 of FIG. 2) to implement failsafe scenarios, in accordance with various embodiments. In block 502, the load-balancing computer system maintains at least two distributed databases (e.g., the record databases pair 108 of FIG. 1 or the record databases 210 of FIG. 2). At least a first distributed database is designated as a production cell and at least a second distributed database is designated as a backup cell. In block 504, the load-balancing computer system writes separately to both the first distributed database and the second distributed database, in response to receiving a write request at the load-balancing computer system.

In block 506, the load-balancing computer system maintains a first error account of the first distributed database and a second error account of the second distributed database. Execution of block 506 may also be in response to receiving the write request at the load-balancing computer system. In block 508, the load-balancing computer system switches, in response to the first error count exceeding the second error count by a threshold amount, designations of the first distributed database to the backup cell and the second distribute database to the production cell.

In block 510, the load-balancing computer system can perform a consistency check between the production cell and the backup cell. The consistency check can be performed asynchronous to the process steps described in blocks 506 and 508. Block 510 can be in response to the load-balancing computer system determining that a preset condition is met. For example, the preset condition may be in accordance with a time-based schedule (e.g., a CRON job).

For another example, meeting the preset condition can include receiving a threshold number of data access requests (e.g., read requests only, write requests only, or any type of data access requests). The last request that meets the threshold number can then trigger the consistency check. In some embodiments, performing the consistency check includes verifying consistency of data between the production cell and the backup cell only for a user account that has most recently requested access to the production cell. That is, the consistency check is performed only on a single user's data. This feature is advantageous to reduce processor and memory requirements when running the consistency checks.

In block 512, the load-balancing computer system can copy data (e.g., all of the data or a subset of the total data) from the production cell to the backup cell. Block 512 can be in response to the consistency check failing beyond a threshold level (e.g., the load-balancing computer system detecting more than a threshold number of inconsistencies between the production cell and the backup cell).

While processes or methods are presented in a given order (e.g., FIG. 4 and FIG. 5), alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times.

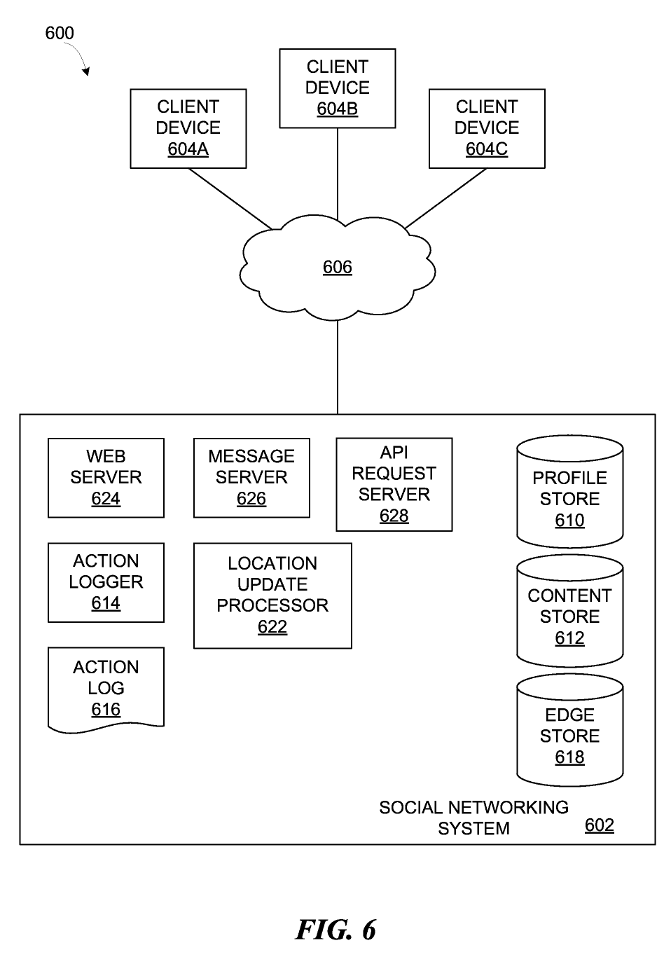

FIG. 6 is a high-level block diagram of a system environment 600 suitable for a social networking system 602, in accordance with various embodiments. The system environment 600 shown in FIG. 6 includes the social networking system 602 (e.g., the social networking system 100 of FIG. 1 or the social networking system 200 of FIG. 2), a client device 604A, and a network channel 606. The system environment 600 can include other client devices as well, e.g., a client device 604B and a client device 604C. The client devices 604A, 604B, and 604C, for example, can include the client devices 102 of FIG. 1 or the client devices 202 of FIG. 2, or any combination thereof. In other embodiments, the system environment 600 may include different and/or additional components than those shown by FIG. 6.

### Social Networking System Environment and Architecture

The social networking system 602, further described below, comprises one or more computing devices storing user profiles associated with users (i.e., social networking accounts) and/or other objects as well as connections between users and other users and/or objects. Users join the social networking system 602 and then add connections to other users or objects of the social networking system to which they desire to be connected. Users of the social networking system 602 may be individuals or entities, e.g., businesses, organizations, universities, manufacturers, etc. The social networking system 602 enables its users to interact with each other as well as with other objects maintained by the social networking system 602. In some embodiments, the social networking system 602 enables users to interact with third-party websites and a financial account provider.

Based on stored data about users, objects and connections between users and/or objects, the social networking system 602 generates and maintains a “social graph” comprising multiple nodes interconnected by multiple edges. Each node in the social graph represents an object or user that can act on another node and/or that can be acted on by another node. An edge between two nodes in the social graph represents a particular kind of connection between the two nodes, which may result from an action that was performed by one of the nodes on the other node. For example, when a user identifies an additional user as a friend, an edge in the social graph is generated connecting a node representing the first user and an additional node representing the additional user. The generated edge has a connection type indicating that the users are friends. As various nodes interact with each other, the social networking system 602 adds and/or modifies edges connecting the various nodes to reflect the interactions.

The client device 604A is a computing device capable of receiving user input as well as transmitting and/or receiving data via the network channel 606. In at least one embodiment, the client device 604A is a conventional computer system, e.g., a desktop or laptop computer. In another embodiment, the client device 604A may be a device having computer functionality, e.g., a personal digital assistant (PDA), mobile telephone, a tablet, a smart-phone or similar device. In yet another embodiment, the client device 604A can be a virtualized desktop running on a cloud computing service. The client device 604A is configured to communicate with the social networking system 602 via a network channel 606 (e.g., an intranet or the Internet). In at least one embodiment, the client device 604A executes an application enabling a user of the client device 604A to interact with the social networking system 602. For example, the client device 604A executes a browser application to enable interaction between the client device 604A and the social networking system 602 via the network channel 606. In another embodiment, the client device 604A interacts with the social networking system 602 through an application programming interface (API) that runs on the native operating system of the client device 604A, e.g., IOS® or ANDROID™.

The client device 604A is configured to communicate via the network channel 606, which may comprise any combination of local area and/or wide area networks, using both wired and wireless communication systems. In at least one embodiment, the network channel 606 uses standard communications technologies and/or protocols. Thus, the network channel 606 may include links using technologies, e.g., Ethernet, 802.11, worldwide interoperability for microwave access (WiMAX), 3G, 4G, CDMA, digital subscriber line (DSL), etc. Similarly, the networking protocols used on the network channel 606 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network channel 606 may be represented using technologies and/or formats including hypertext markup language (HTML) or extensible markup language (XML). In addition, all or some of links can be encrypted using conventional encryption technologies, e.g., secure sockets layer (SSL), transport layer security (TLS), and Internet Protocol security (IPsec).

The social networking system 602 includes a profile store 610, a content store 612, an action logger 614, an action log 616, an edge store 618, a location update processor 622, a web server 624, a message server 626, and an API request server 628. The profile store 610 and/or the edge store 618 can be at least partially implemented by the derivative data bank 112 of FIG. 1, the social graph store 114 of FIG. 1., the user profile persistent storage 218 of FIG. 2, the user profile data cache 220 of FIG. 2, or any combination thereof. The action log 616 can be implemented at least partially by the record databases pair 108 of FIG. 1 or the record databases 210 of FIG. 2. The location update processor 622 can be implemented at least partially by the load-balancing engine 106 of FIG. 1 or the load-balancing server tier 206 of FIG. 2. In other embodiments, the social networking system 602 may include additional, fewer, or different modules for various applications.

User of the social networking system 602 can be associated with a user profile, which is stored in the profile store 610. The user profile is associated with a social networking account. A user profile includes declarative information about the user that was explicitly shared by the user, and may include profile information inferred by the social networking system 602. In some embodiments, a user profile includes multiple data fields, each data field describing one or more attributes of the corresponding user of the social networking system 602. The user profile information stored in the profile store 610 describes the users of the social networking system 602, including biographic, demographic, and other types of descriptive information, e.g., work experience, educational history, gender, hobbies or preferences, location and the like. A user profile may also store other information provided by the user, for example, images or videos. In some embodiments, images of users may be tagged with identification information of users of the social networking system 602 displayed in an image. A user profile in the profile store 610 may also maintain references to actions by the corresponding user performed on content items (e.g., items in the content store 612) and stored in the edge store 618 or the action log 616.

A user profile may be associated with one or more financial accounts, enabling the user profile to include data retrieved from or derived from a financial account. In some embodiments, information from the financial account is stored in the profile store 610. In other embodiments, it may be stored in an external store.

A user may specify one or more privacy settings, which are stored in the user profile, that limit information shared through the social networking system 602. For example, a privacy setting limits access to cache appliances associated with users of the social networking system 602.

The content store 612 stores content items (e.g., images, videos, or audio files) associated with a user profile. The content store 612 can also store references to content items that are stored in an external storage or external system. Content items from the content store 612 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users, to invite new users to the system or to increase interaction with the social networking system by displaying content related to users, objects, activities, or functionalities of the social networking system 602. Examples of social networking content items include suggested connections or suggestions to perform other actions, media provided to, or maintained by, the social networking system 602 (e.g., pictures or videos), status messages or links posted by users to the social networking system, events, groups, pages (e.g., representing an organization or commercial entity), and any other content provided by, or accessible via, the social networking system.

The content store 612 also includes one or more pages associated with entities having user profiles in the profile store 610. An entity can be a non-individual user of the social networking system 602, e.g., a business, a vendor, an organization, or a university. A page includes content associated with an entity and instructions for presenting the content to a social networking system user. For example, a page identifies content associated with the entity's user profile as well as information describing how to present the content to users viewing the brand page. Vendors may be associated with pages in the content store 612, enabling social networking system users to more easily interact with the vendor via the social networking system 602. A vendor identifier is associated with a vendor's page, thereby enabling the social networking system 602 to identify the vendor and/or to retrieve additional information about the vendor from the profile store 610, the action log 616 or from any other suitable source using the vendor identifier. In some embodiments, the content store 612 may also store one or more targeting criteria associated with stored objects and identifying one or more characteristics of a user to which the object is eligible to be presented.

The action logger 614 receives communications about user actions on and/or off the social networking system 602, populating the action log 616 with information about user actions. Such actions may include, for example, adding a connection to another user, sending a message to another user, uploading an image, reading a message from another user, viewing content associated with another user, attending an event posted by another user, among others. In some embodiments, the action logger 614 receives, subject to one or more privacy settings, content interaction activities associated with a user. In addition, a number of actions described in connection with other objects are directed at particular users, so these actions are associated with those users as well. These actions are stored in the action log 616.

In accordance with various embodiments, the action logger 614 is capable of receiving communications from the web server 624 about user actions on and/or off the social networking system 602. The action logger 614 populates the action log 616 with information about user actions to track them. This information may be subject to privacy settings associated with the user. Any action that a particular user takes with respect to another user is associated with each user's profile, through information maintained in a database or other data repository, e.g., the action log 616. Such actions may include, for example, adding a connection to the other user, sending a message to the other user, reading a message from the other user, viewing content associated with the other user, attending an event posted by another user, being tagged in photos with another user, liking an entity, etc.

The action log 616 may be used by the social networking system 602 to track user actions on the social networking system 602, as well as external website that communicate information to the social networking system 602. Users may interact with various objects on the social networking system 602, including commenting on posts, sharing links, and checking-in to physical locations via a mobile device, accessing content items in a sequence or other interactions. Information describing these actions is stored in the action log 616. Additional examples of interactions with objects on the social networking system 602 included in the action log 616 include commenting on a photo album, communications between users, becoming a fan of a musician, adding an event to a calendar, joining a groups, becoming a fan of a brand page, creating an event, authorizing an application, using an application and engaging in a transaction. Additionally, the action log 616 records a user's interactions with advertisements on the social networking system 602 as well as applications operating on the social networking system 602. In some embodiments, data from the action log 616 is used to infer interests or preferences of the user, augmenting the interests included in the user profile, and enabling a more complete understanding of user preferences.

Further, user actions that happened in particular context, e.g., when the user was shown or was seen accessing particular content on the social networking system 602, can be captured along with the particular context and logged. For example, a particular user could be shown/not-shown information regarding candidate users every time the particular user accessed the social networking system 602 for a fixed period of time. Any actions taken by the user during this period of time are logged along with the context information (i.e., candidate users were provided/not provided to the particular user) and are recorded in the action log 616. In addition, a number of actions described below in connection with other objects are directed at particular users, so these actions are associated with those users as well.

The action log 616 may also store user actions taken on external websites services associated with the user. The action log 616 records data about these users, including viewing histories, advertisements that were engaged, purchases or rentals made, and other patterns from content requests and/or content interactions.

In some embodiments, the edge store 618 stores the information describing connections between users and other objects on the social networking system 602 in edge objects. The edge store 618 can store the social graph described above. Some edges may be defined by users, enabling users to specify their relationships with other users. For example, users may generate edges with other users that parallel the users' real-life relationships, e.g., friends, co-workers, partners, and so forth. Other edges are generated when users interact with objects in the social networking system 602, e.g., expressing interest in a page or a content item on the social networking system, sharing a link with other users of the social networking system, and commenting on posts made by other users of the social networking system. The edge store 618 stores edge objects that include information about the edge, e.g., affinity scores for objects, interests, and other users. Affinity scores may be computed by the social networking system 602 over time to approximate a user's affinity for an object, interest, and other users in the social networking system 602 based on the actions performed by the user. Multiple interactions of the same type between a user and a specific object may be stored in one edge object in the edge store 618, in at least one embodiment. In some embodiments, connections between users may be stored in the profile store 610. In some embodiments, the profile store 610 may reference or be referenced by the edge store 618 to determine connections between users. Users may select from predefined types of connections, or define their own connection types as needed.

The web server 624 (e.g., the service server component 104 of FIG. 1 or the web service system 214 of FIG. 2) links the social networking system 602 via a network to one or more client devices; the web server 624 serves web pages, as well as other web-related content, e.g., Java, Flash, XML, and so forth. The web server 624 may communicate with the message server 626 that provides the functionality of receiving and routing messages between the social networking system 602 and client devices. The messages processed by the message server 626 can be instant messages, email messages, text and SMS (short message service) messages, photos, or any other suitable messaging technique. In some embodiments, a message sent by a user to another user can be viewed by other users of the social networking system 602, for example, by the connections of the user receiving the message. An example of a type of message that can be viewed by other users of the social networking system besides the recipient of the message is a wall post. In some embodiments, a user can send a private message to another user that can only be retrieved by the other user.

The application program interface (API) request server 628 enables external systems to access information from the social networking system 602 by calling APIs. The information provided by the social network may include user profile information or the connection information of users as determined by their individual privacy settings. For example, a system interested in predicting the probability of users forming a connection within a social networking system may send an API request to the social networking system 602 via a network. The API request server 628 of the social networking system 602 receives the API request. The API request server 628 processes the request by determining the appropriate response, which is then communicated back to the requesting system via a network.

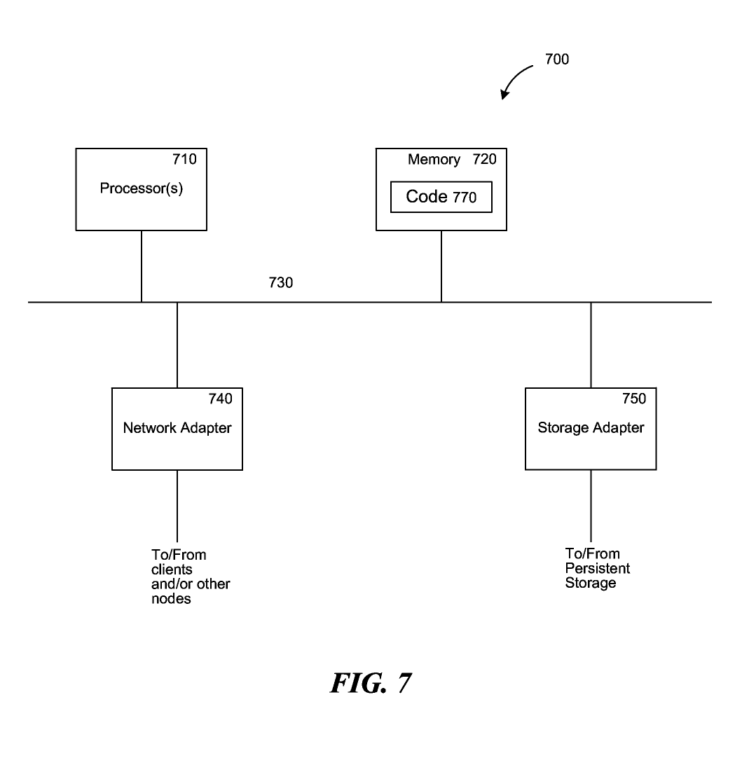

A location update processor 622 can implement one or more methods to load-balancing processing and storage of location-based information through the social networking system 602. The methods can be implemented by various components (e.g., data storages, engines, or other modules) described in FIG. 1 or FIG. 2. The components can be implemented as hardware components, software components, or any combination thereof. For example, the components described can be software components implemented as instructions on a non-transitory memory capable of being executed by a processor or a controller on a machine described in FIG. 7. For another example, the methods and other techniques introduced in the modules above can be implemented by programmable circuitry programmed or configured by software and/or firmware, or they can be implemented entirely by special-purpose “hardwired” circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Each of the components can operate individually and independently of other components. Some or all of the components can be combined as one components. A single component can also be divided into sub-components, each performing a separate method step or method steps of the single component. The components can share access to a memory space. One component can access data accessed by or transformed by another component. The components can be considered “coupled” to one another if they share a physical connection or a virtual connection, directly or indirectly, enabling data accessed or modified from one component to be accessed in another component. Each of the data storages can operate individually and independently of other data storages. Some or all of the data storages can be combined as one data storage. A single data storage can also be divided into sub-storages, each containing a portion of the single data storage.

The storages or “stores,” described below are hardware components or portions of hardware components for storing digital data. Each of the storage can be a single physical entity or distributed through multiple physical devices. Each of the storage can be on separate physical devices or share the same physical device or devices. Each of the stores can allocate specific storage spaces for run-time applications, processes, or modules. The systems described can include additional, fewer, or different modules for various applications.

FIG. 7 is a block diagram of an example of a computing device 700, which may represent one or more computing device or server described herein, in accordance with various embodiments. The computing device 700 can be one or more computing devices that implement the social networking system 100 of FIG. 1 or the social networking system 200 of FIG. 2. For example, the computing device 700 can implement one or more of the service server component 104, the load-balancing engine 106, the record databases pair 108, the analytic engine 110, and the derivative databank 112 of FIG. 1 and one or more of the real-time gateway 204, the load-balancing server tier 206, the record databases 210, the web service system 214, and other components of FIG. 2. The computing device 700 includes one or more processors 710 and memory 720 coupled to an interconnect 730. The interconnect 730 shown in FIG. 7 is an abstraction that represents any one or more separate physical buses, point-to-point connections, or both connected by appropriate bridges, adapters, or controllers. The interconnect 730, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 710 is/are the central processing unit (CPU) of the computing device 700 and thus controls the overall operation of the computing device 700. In certain embodiments, the processor(s) 710 accomplishes this by executing software or firmware stored in memory 720. The processor(s) 710 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 720 is or includes the main memory of the computing device 700. The memory 720 represents any form of random access memory (RAM), read-only memory (ROM), flash memory, or the like, or a combination of such devices. In use, the memory 720 may contain a code 770 containing instructions according to the mesh connection system disclosed herein.

Also connected to the processor(s) 710 through the interconnect 730 are a network adapter 740 and a storage adapter 750. The network adapter 740 provides the computing device 700 with the ability to communicate with remote devices, over a network and may be, for example, an Ethernet adapter or Fibre Channel adapter. The network adapter 740 may also provide the computing device 700 with the ability to communicate with other computers. The storage adapter 750 enables the computing device 700 to access a persistent storage, and may be, for example, a Fibre Channel adapter or SCSI adapter.

The code 770 stored in memory 720 may be implemented as software and/or firmware to program the processor(s) 710 to carry out actions described above. In certain embodiments, such software or firmware may be initially provided to the computing device 700 by downloading it from a remote system through the computing device 700 (e.g., via network adapter 740).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

Some embodiments of the disclosure have other aspects, elements, features, and steps in addition to or in place of what is described above. These potential additions and replacements are described throughout the rest of the specification. For example, some embodiments include a social networking system comprising: a first database that is distributed, scalable, and non-relational and a second database that is distributed, scalable, and non-relational. The first database can be configured to store location-based (historical) records of user accounts in the social networking system. When the first database is designated as a production cell, the first database is configured to respond to data requests for the location-based records. The second database can be configured to store location-based (historical) records of user accounts in the social networking system. When the second database is designated as a backup cell, the second database is configured to respond to data requests for the location-based records. The social networking system can further comprise: a load-balancing computer system configured to receive a raw location update from a mobile device or a location-based context update associated with a user account and to double write the raw location update or the location-based context update to the first database and the second database; wherein the load-balancing computer system is configured to switch designations of the production cell and the backup cell between the first database and the second database depending on error counts corresponding to the first database and the second database; and a web service computer system configured to receive the raw location update from the load-balancing computer system in response to the load-balancing computer system receiving the raw location update and to compute the location-based context update based on the raw location update. In some embodiments, the web service computer system is configured to store at least a portion of the location-based context update to the user profile persistent storage, the user profile data cache, or both the first database and the second database. When storing a portion of the location-based context update to both the first database and the second database, the web service computer system can use the load-balancing computer system as a proxy.

The social networking system can further comprise: a real-time gateway server configured to receive raw location updates from mobile devices and to forward the raw location updates to the load-balancing computer system; and a channel selector component configured to identify the real-time gateway server that corresponds to a mobile device, wherein the web service computer system is configured to request the channel selector component to identify the real-time gateway server when sending a message to the mobile device. In some embodiments, the social networking system also comprises: user profile persistent storage configured to store user profile information; and user profile data cache configured to store a subset of the user profile information. The web service computer system can be configured to compute the location-based context update based also on the user profile information

What is claimed is:

1. A computer-implemented method comprising:
receiving, by a load-balancing computer system, a location-based record update associated with a user account;
writing, by the load-balancing computer system, the location-based record update separately to at least two different databases;
forwarding, by the load-balancing computer system, the location-based record update to an analytic engine of a web service computer system;
receiving, by the load-balancing computer system, a first derivative dataset computed based on the location-based record from the analytic engine; and
writing, by the load-balancing computer system, the first derivative dataset separately to the databases, wherein the databases includes a primary cell database designated to respond to a client request for the location-based record or the first derivative dataset and a backup cell database designated to switch designated roles with the primary cell database when the primary cell database is determined to be failing.

2. The computer-implemented method of claim 1, wherein receiving the location-based record update includes receiving the location-based record update from a real-time gateway that services multiple mobile devices, wherein at least one of the mobile devices is associated with the user account.

3. The computer-implemented method of claim 1, wherein the databases are distributed and scalable databases.

4. The computer-implemented method of claim 3, wherein the databases are implemented as HBase databases.

5. The computer-implemented method of claim 3, wherein writing the location-based record update to the databases occur substantially simultaneously.

6. The computer-implemented method of claim 1, further comprising:
the analytic engine computing derivative data based on the location-based record update and user profile data, the user profile data accessible from a user profile persistent storage or a user profile data cache coupled to the web service computer system, the derivative data including the first derivative dataset; and
sending the first derivative dataset to the load-balancing computer system.

7. The computer-implemented method of claim 6, wherein the derivative data includes a second derivative dataset; and further comprising:
writing the second derivative dataset to the user profile persistent storage or the user profile data cache without sending the second derivative dataset to the load-balancing computer system.

8. The computer-implemented method of claim 1, wherein receiving the first derivative dataset includes receiving at least two separate copies of the first derivative dataset at two data interface program instances executing in the load-balancing computer system.

9. The computer-implemented method of claim 8, further comprising routing, by at least one of the data interface program instances, a data request from the web service computer system to at least one of the databases serving as the production cell database.

10. The computer-implemented method of claim 1, wherein the location-based record update includes a raw location record associated with the user account and metadata associated with the raw location record.

11. The computer-implemented method of claim 10, wherein the first derivative dataset includes a significant movement of the user account.

12. A computer readable memory storing instructions, comprising:
instructions for maintaining, by a load-balancing computer system, at least two distributed databases, wherein at least a first distributed database is designated as a production cell and at least a second distributed database is designated as a backup cell;
instructions for, in response to receiving a write request at the load-balancing computer system, writing, by the load-balancing computer system, separately to both the first distributed database and the second distributed database;
instructions for, in response to receiving the write request at the load-balancing computer system, maintaining, by the load-balancing computer system, a first error count of the first distributed database and a second error count of the second distributed database; and
instructions for, in response to the first error count exceeding the second error count by a threshold amount, switching designations of the first distributed database to the backup cell and the second distribute database to the production cell.

13. The computer readable memory of claim 12, further comprising
instructions for performing a consistency check between the production cell and the backup cell in response to meeting a preset condition; and
instructions for, in response to the consistency check failing beyond a threshold level, copying data from the production cell to the backup cell.

14. The computer readable memory of claim 13, wherein meeting the preset condition includes meeting a time-based schedule.

15. The computer readable memory of claim 13, wherein meeting the preset condition includes receiving a threshold number of data access requests.

16. The computer readable memory of claim 15, wherein the data access requests are read requests only.

17. The computer readable memory of claim 13, wherein performing the consistency check includes verifying consistency of data between the production cell and the backup cell for a user account that has most recently requested access to the production cell.

18. A social networking system comprising:
a first database that is a distributed database, the first database configured to store location-based records of user accounts in the social networking system, wherein, in an event that the first database is designated as a production cell, the first database is configured to respond to data requests for the location-based records;
a second database that is a distributed database, the second database configured to store location-based records of user accounts in the social networking system, wherein, in an event that the second database is designated as a backup cell, the second database is configured to respond to data requests for the location-based records;
a load-balancing computer system configured to receive a raw location update or a location-based context update associated with a user account and to double write the raw location update or the location-based context update to the first database and the second database;
wherein the load-balancing computer system is configured to switch designations of the production cell and the backup cell between the first database and the second database depending on error counts corresponding to the first database and the second database; and
a web service computer system configured to receive the raw location update from the load-balancing computer system in response to the load-balancing computer system receiving the raw location update and to compute the location-based context update based on the raw location update,
wherein the web service computer system is configured to store at least a portion of the location-based context update to both the first database and the second database via the load-balancing computer as a proxy.

19. The social networking system of claim 18, further comprising:
a real-time gateway server configured to receive raw location updates from mobile devices and to forward the raw location updates to the load-balancing computer system; and
a channel selector component configured to identify the real-time gateway server that corresponds to a mobile device, wherein the web service computer system is configured to request the channel selector component to identify the real-time gateway server when sending a message to the mobile device.

20. The social networking system of claim 18, further comprising:
user profile persistent storage configured to store user profile information; and
user profile data cache configured to store a subset of the user profile information,
wherein the web service computer system is configured to compute the location-based context update based also on the user profile information.
